(19) United States
(12) Patent Application Publication
(10) Pub. No.: US 2014/0266014 A1
(43) Pub. Date: Sep. 18, 2014

(54) Embedded Power Supplying Device Using in Desk

(71) Applicants: Ming-Yuan Pai, Shenzhen (CN); Chao-Yu Yueh, Taipei City (TW)

(72) Inventors: Ming-Yuan Pai, Shenzhen (CN); Chao-Yu Yueh, Taipei City (TW)

(21) Appl. No.: 14/033,759

(22) Filed: Sep. 23, 2013

(30) Foreign Application Priority Data
Mar. 12, 2013 (CN) 201320112176.7

(51) Int. Cl. H02J 7/00

(52) U.S. Cl. CPC H02J 7/0042
USPC 320/107; 439/544

(57) ABSTRACT

A power supplying device is embedding in a hole of a desk. The power supplying device includes an annular base, a ring, and a charging body. The annular base has a through hole. The ring is surrounded the annular base. The charging body has a shell and a charging circuit, which is located in the shell. An outer sidewall of the shell contacted with the through hole of the annular base. A concave for passing through a wire is formed on the outer sidewall. A maximum outer diameter of the shell is adapted to an inner diameter of the through hole of the annular base. An outer diameter of the ring is greater than an inner diameter of the hole of the desk.

### CROSS REFERENCE TO RELATED APPLICATIONS

This Non-provisional application claims priority under 35 U.S.C. §119(a) on Patent Application No. 201320112176.7 filed in People's Republic of China on Mar. 12, 2013, the entire contents of which are hereby incorporated by reference.

### BACKGROUND

1. Technical Field

The disclosure relates to a power supplying device, in particularly, to a power supplying device embedded in a desk.

2. Description of Related Art

Electronic devices have become an indispensable tool in the life. After a period of use, the electronic device requires recharging to keep operating. When charging, the electronic device can be connected to mains via a power adaptor or connected to a computer via a USB cable.

However, the power socket and the computer are often located on the ground in the office so that the user is difficult to do the connection. In addition, the charging cable cannot be effectively integrated and resulting in cluttered work environment.

It is therefore an important subject of the invention to provide a power supplying device using in a desk.

### SUMMARY OF THE INVENTION

In view of the foregoing, the invention is to provide embedded power supplying device, which is using in a desk to overcome the deficiencies of the prior art.

To achieve the above, a power supplying device is embedding in a wire hole of a desk. The power supplying device includes an annular base, a ring, and a charging body. The annular base has a through hole. The ring is surrounded the annular base. The charging body has a shell and a charging circuit, which is located in the shell. An outer sidewall of the shell contacted with the through hole of the annular base. A concave for passing through a wire is formed on the outer sidewall. A maximum outer diameter of the shell is adapted to an inner diameter of the wire hole of the desk. An outer diameter of the ring is greater than an inner diameter of the wire hole of the desk.

In one embodiment, the shell is screwed with the annular base.

In one embodiment, the charging circuit is an USB charging circuit. An USB socket is electrically connected to the USB charging circuit, and is exposed to a top of the shell. A power line with a plug is electrically connected to the USB charging circuit, and is exposed to a bottom of the shell.

In one embodiment, the charging circuit is a wireless charging circuit. A power line with a plug is electrically connected to the wireless charging circuit, and is exposed to a bottom of the shell.

To achieve the above, a power supplying device is adapted to a wire hole of a desk. The power supplying device includes a columnar body, a fixing base, a power socket, and a power converter. The columnar body has a top, a bottom, and a side wall between the top and the bottom. The fixing base is adjacent to the top and surrounded the columnar body. A maximum outer diameter of the fixing base is greater than a diameter of the wire hole of the desk. The power socket is exposed to the top of the columnar body. The power converter is contained in the columnar body, and electrically connected to the power socket and a mains.

In one embodiment, the power supplying device further includes a pass through hole, which is formed between a part of the top, the side wall, and the fixing base. The pass through hole is for passing at least one transmission line or power core.

In one embodiment, a screw thread is formed on a part of the side wall of the columnar body.

In one embodiment, the fixing base includes a positioned member and a supporting member. The positioned member is surrounded the columnar body. The supporting member is surrounded the positioned member.

In one embodiment, the positioned member is a hollow ring surrounded the columnar body.

In one embodiment, the positioned member, the supporting member, and the columnar body are integrated forming.

As mentioned above, the power supplying device can be embedded in the wire hole of the desk to centralize the wires in the same area for easily using. Thus, the electronic devices can be placed on the desk or in the particular area during recharging to save the office space for working.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic diagram showing an embedded power supplying device according to a first embodiment of the invention.

FIG. 2 is an exploded view showing the embedded power supplying device installed with a desk according to the first embodiment of the invention.

FIG. 3 is a schematic diagram showing an embedded power supplying device using in a desk according to the first embodiment of the invention.

FIG. 4 is a schematic diagram showing an embedded power supplying device according to a second embodiment of the invention.

FIG. 5 is a schematic diagram showing the embedded power supplying device using in a desk according to the second embodiment of the invention.

FIG. 6 is a schematic diagram showing an embedded power supplying device according to a third embodiment of the invention.

FIG. 7 is a schematic diagram showing an embedded power supplying device according to a fourth embodiment of the invention.

### DETAILED DESCRIPTION

Reference will now be made to the drawings to describe various inventive embodiments of the present disclosure in detail, wherein like numerals refer to like elements throughout.

Referring to FIGS. 1-3, an embedded power supplying device includes a charging body. The charging body is consisted of a shell 1 and a charging circuit (not shown) located in the shell 1.

An outer sidewall of the shell 1 is contacted with a through hole of an annular base 2. In one embodiment, an outer screw thread 14 is formed on an outer sidewall of the shell 1, and an inner screw thread 22 is formed on an inner sidewall of the annular base 2. The outer screw thread 14 is adapted to the inner screw thread 22 so that the shell 1 is screwed with the annular base 2.

A ring 21 is surrounded the annular base 2. A concave 12 is formed on the outer sidewall of the shell 1. The concave 12 is for passing through wires.

In the embodiment, a maximum outer diameter of the shell 1 is adapted to an inner diameter of a wire hole 101 of the desk 100. An outer diameter of the ring is greater than an inner diameter of the wire hole 101 of the desk 100.

In the embodiment, the charging circuit is an USB charging circuit. There is at least one USB socket 11 fixed and exposed to a top of the shell 1. A power line with a plug 13 is electrically connected to the USB charging circuit, and is exposed to a bottom of the shell 1. The USB socket 11 and the power line are electrically connected to the USB charging circuit, respectively.

Referring to FIG. 2, an operation process of the embedded power supplying device includes steps of S1 to S3.

Step S1 is screwing the shell 1 with the annular base 2.

Step S2 is placing the wire 200 passing through the wire hole 101 from the bottom of the desk 100 to the desktop. The wire 200 may be a mouse cable or keyboard cable.

Step S3 is placing the plug 13, the power line, and shell 1 into the wire hole 101. Thus, the ring 21 can contact to the desktop around the wire hole 101 to stick on the desk 100 to avoid the power supplying device dropping through the wire hole 101 (shown in FIG. 3).

Additionally, the charging circuit can be a wireless charging circuit. Thus, the power line with the plug is electrically connected to the wireless charging circuit, and is exposed to a bottom of the shell.

Referring to FIG. 4, in another embodiment, an embedded power supplying device 30 includes a columnar body 31, a fixing base 32, a power socket 33, and a power converter 34.

The columnar body 31 has a top 311, a bottom 312, and a side wall 313 located between the top 311 and the bottom 312. The fixing base 32 is adjacent to the top 311 and surrounded the columnar body 31.

The power socket 33 is an USB socket, which is exposed to the top 311 of the columnar body 31 for connecting the USB cable. The power converter 34 is contained in the columnar body 31. The power converter 34 is electrically connected to the power socket 33 by at least one transmission line, and electrically connected to a mains by a power core 36.

Referring to FIG. 5, in the embodiment, the power supplying device 30 is adapted to a wire hole 41 of a desk 40.

The fixing base 32 includes a positioned member 321 and a supporting member 322. The positioned member 321 is a hollow ring, which is surrounded the columnar body 31. In the embodiment, the hollow ring is adjacent to the top 311 and surrounded a part of the side wall 313. The supporting member 322 is surrounded the positioned member 322 to support the fixing base 32 stay on the wire hole 41 of the desk 40.

In the embodiment, a maximum outer diameter of the fixing base 32 is greater than a diameter of the wire hole 41 of the desk 40. In addition, the positioned member 321, the supporting member 322, and a part of the side wall 313 of the columnar body 31 are integrated forming.

Moreover, a screw thread 314 is formed on a part of the side wall 313 of the columnar body 31 and adjacent to the bottom 312. A packing ring 35 is screwed with the columnar body 31 by the screw thread 314. Therefore, the desk 40 is gripped by the fixing base 32 and the packing ring 35 to fix the power supplying device.

Referring to FIG. 6, in one embodiment, a part of the side wall 613 of the columnar body 61 is connected to the positioned member 521 by fastening. In the embodiment, the positioned member 521 is extended into the wire hole 41 and has a concave portion C1, and the side wall 613 has a protruding portion P1. The positioned member 521 can be tight fitted in the wire hole 41, and the concave portion C1 and the protruding portion P1 are fastened to each other. In another embodiment, the columnar body 61 can be connected to the positioned member 521 by screwing or adhering.

Referring to FIG. 7, in one embodiment, the power supplying device 30a further includes a pass through hole 35. The through hole 35 is formed between a part of the top 311, the side wall 313, and the fixing base 32. The pass through hole 35 is for passing at least one transmission line or power core.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A power supplying device is embedding in a wire hole of a desk, comprising:
an annular base having a through hole;
a ring surrounded the annular base; and
a charging body having a shell and a charging circuit, which is located in the shell,
an outer sidewall of the shell contacted with the through hole of the annular base,
and a concave for passing through a wire formed on the outer sidewall,
wherein a maximum outer diameter of the shell is adapted to an inner diameter of the wire hole of the desk, and an outer diameter of the ring is greater than an inner diameter of the wire hole of the desk.

2. The power supplying device of claim 1, wherein the shell is screwed with the annular base.

3. The power supplying device of claim 1, wherein the charging circuit is an USB charging circuit.

4. The power supplying device of claim 3, further comprising:
an USB socket electrically connected to the USB charging circuit, and exposed to a top of the shell; and
a power line with a plug electrically connected to the USB charging circuit, and exposed to a bottom of the shell.

5. The power supplying device of claim 1, wherein the charging circuit is a wireless charging circuit.

6. The power supplying device of claim 5, further comprising a power line with a plug electrically connected to the wireless charging circuit, and exposed to a bottom of the shell.

7. A power supplying device is adapted to a wire hole of a desk, comprising:
a columnar body having a top, a bottom, and a side wall between the top and the bottom;
a fixing base adjacent to the top and surrounded the columnar body, and a maximum outer diameter of the fixing base is greater than a diameter of the wire hole of the desk;
a power socket exposed to the top of the columnar body; and
a power converter contained in the columnar body, and electrically connected to the power socket and a mains.

8. The power supplying device of claim 7, further comprising:
a pass through hole, which is formed between a part of the top, the side wall, and the fixing base.

9. The power supplying device of claim 7, wherein a screw thread is formed on a part of the side wall of the columnar body.

10. The power supplying device of claim 9, further comprising:
a packing ring, which is screwed with the columnar body by the screw thread.

11. The power supplying device of claim 7, wherein the fixing base comprising:
a positioned member, which is surrounded the columnar body; and
a supporting member, which is surrounded the positioned member.

12. The power supplying device of claim 11, wherein the positioned member is a hollow ring.

13. The power supplying device of claim 11, wherein the positioned member, the supporting member, and the columnar body is integrated forming.
